(19) United States
(12) Patent Application Publication
(10) Pub. No.: US 2016/0037723 A1
(43) Pub. Date: Feb. 11, 2016

(54) CROP THRESHING METHOD

(71) Applicants: Zharylkasyn SADYKOV, ALMATY (KZ); Saule SADYKOVA, Almaty (KZ)

(72) Inventors: Zharylkasyn SADYKOV, ALMATY (KZ); Saule SADYKOVA, Almaty (KZ)

(21) Appl. No.: 14/886,057

(22) Filed: Oct. 18, 2015

Related U.S. Application Data
(63) Continuation-in-part of application No. 13/978,533, filed on Feb. 14, 2014, now abandoned.

(51) Int. Cl. A01F 12/00; A01F 7/02; A01F 12/18

(52) U.S. Cl. CPC A01F 12/00; A01F 12/182; A01F 7/02; A01F 12/181

(57) ABSTRACT

A crop threshing method involves threshing a grain crop, thereby causing the grain to separate into an edible grain portion and a non-grain portion of the crop. The threshing process uses a beater-type threshing drum, and continuously exposing the edible portion traveling through the threshing drum to a magnetic fields. Magnetic exposure of the edible portion during the threshing process is conducted by increasing the initial speed of crop mass fed into the threshing drum from 1.8 to 8.0 meters per second, a distance between threshing hammers during the threshing process is increased from 180 mm to 280 mm, and the number of threshing hammers is increased from six to twelve. Magnetic exposure of the edible portion during the threshing process is conducted by increasing the drum diameter from 380 mm to 800 mm with a constant developed concave length.

### RELATED APPLICATIONS

This application claims priority to and is a continuation of U.S. patent application Ser. No. 13/978,533 “Crop Threshing Method,” which was filed on Feb. 14, 2014, which claims the benefit of the Jan. 5, 2011 priority filing date in PCT1KZ2011/000020, referenced in WIPO Pub. No. WO2012/115494. Each of the foregoing applications is incorporated here by reference in its entirety.

### BACKGROUND

1. Field of the Invention

The present invention generally relates to methods for threshing crops. More specifically, to methods for threshing crops by magnetically treating the freshly threshed seeds in order to alter their biophysical, biochemical and physiochemical properties. The present invention can be used in agriculture to magnetize seeds when threshing different types of crops during harvesting.

2. Related Art

A method for threshing and harvesting crops in which plants are cut by a combine harvester header and threshed with the thresher operating in a “sparing” mode is known. See, Sadykov, Zh. S, pat. KZ No 1131, A01D 91/04, 45/30, published 15 Sep. 1994, Bulletin No 3. However, the use of the known threshing method when harvesting hard-to-thresh crops results in substantial loss of grain due to under-threshing, resulting in harvest shortfall.

The closest method to the present invention is a crop threshing method wherein threshing is conducted by separating the mass of grain and chaff are separated into an edible portion and a non-grain portion of the crop, informally classified as a combine harvester's threshing mechanism working process. See, Zhalnin, E. V., Axiomatizatoin of Agricultural Mechanics (Basic Terms), M, VIM, 2002, p. 150-168. The authors have selected this method as the prototype.

These methods of threshing seed and grain crops causes grain loss due to grain crushing and micro-damage, which reduces seed germinating ability and crop yield. Quantitatively, Approximately 10% grain is micro-damaged for every 1% of grain crushed, resulting in substantial yield loss.

Also known is a seed treating method that exposes seeds to an electromagnetic field, thereby accelerating certain biochemical reactions and facilitating the alteration of a number of biophysical, biochemical and physicochemical properties. In particular, by applying an electromagnetic field, for instance, in the 3-30 Hz band, it is possible to increase seed germinating ability and crop yield. See, RU Pat. Nos. 2179792 and 2134944. Also, applying an electromagnetic field in the same frequency band accelerates the processes of extraction from root crops, particularly from sugar beets, and increases sugar yield and storage life of harvested beets. See, RU Nos. 2172094, 2172091, 2172095, 2172096, etc.).

All current methods for threshing crops and applying an electromagnetic field to biological objects, such as seeds, are not efficient enough. There is no threshing method that takes into account the particular biological characteristics of a freshly threshed seeds under movement/transport conditions. To achieve the best results, it is necessary to act on a particular portion of freshly threshed seeds as they are transported to the grain hopper of a combine harvester. The seeds are treated with a special field with parameters that are specially selected for a specific type of a crop. This method is new and has no analogues.

The technical objective of the present invention is to attempt to take advantage of specific characteristics of freshly threshed seeds. This is accomplished by selecting a magnetic field with the most efficient parameters and applying it to a portion of seeds during the threshing process in order to activate or suppress biological processes. For example changing the seeds' germinating ability, which affects changes in ripening times, increasing the yield and quality of crops, and their storage life without lowering quality.

The technical result expands the functional capabilities of a known crop threshing method by simultaneously treating the freshly-threshed edible portion of the crop in a continuous mode, i.e., immediately as the crop is threshed and on an ongoing basis.

### SUMMARY

A crop threshing method includes threshing and separating a mass of grain into an edible grain portion and a non-grain portion. The freshly threshed edible portion is magnetically treated during the threshing process, the threshing process using a standard beater-type threshing drum in a continuous mode (i.e., continuously).

The magnetic treatment of the edible portion during the threshing process is performed by increasing the edible portion's initial speed of entry into the threshing mechanism from 1.8 to 8.0 meters per second (m/s), increasing the distance between the hammers from 180 to 280 mm, increasing the number of hammers from 6 to 12, increasing the length of a concave surface of the thresher; and increasing the drum diameter from 380 mm to 800 mm.

The magnetic exposure of the edible portion during threshing is performed with a smaller diameter threshing drum, having a diameter of between 380 mm and 500 mm, but having the same concave length and the same feeding rate. The drum may also have different profiles of drum hammers. There may be open space between the hammers and hammer supports, and the hammers may have an active lead angle of between 30° and 60°. A closed drum (a solid cylinder) is also contemplated having attached hammers with no active lead angle (i.e., under 30°). The ratio of the area under the holes in the drum to the total concave area may be increased from 0% to 40%. Additionally, there may be a variable distance between the concave bars from the start to the end of the concave surface (i.e., with a larger distance in the first and last zones and smaller distance in the middle part of the concave; so that different magnetic fields act on the edible portion of each crop in the optimum manner for each crop.

### BRIEF DESCRIPTION OF THE FIGURES

FIG. 1 illustrates a side view of a grain harvester;

FIG. 2A illustrates a top view of a leveling board;

FIG. 2B illustrates a side view of the leveling board;

FIG. 3A illustrates a side view of a pitched board;

FIG. 3B illustrates a top view of a pitched board;

FIG. 4A illustrates a side view of a hopper;

FIG. 4B illustrates a top view of a hopper;

FIG. 5 illustrates a table showing magnetic zone characteristics

### DESCRIPTION

The crop threshing method is carried out using a different version of traditional threshing technology, in that magnetic fields with optimum parameters for a particular crop type are applied to moving freshly threshed portions of seeds.

In the crop threshing method, the threshing is conducted by separating the edible grain portion and the non-grain portions of the grain crop. The freshly threshed edible portion is continuously magnetically treated during the threshing process using a beater-type threshing drum, using magnetic field levels optimized for a particular type of grain.

During the magnetic treatment of the edible portion, the initial speed of feeding the crop mass through the threshing mechanism increases from 1.8 to 8.0 m/s. The grain separation along a concave surface increases exponentially up to a certain point, while grain under-threshing, straw breakage and unevenness of torque on the drum shaft decreases linearly. At a low speed of feeding the grain to the drum, the difference between the extreme torque values is as high as 50%. The distance between drum hammers is increased from 180 mm to 280 mm, and accordingly, the number of hammers is increased from 6 to 12.

This has no significant effect on grain crushing, but as the number of hammers increases and the distance between them decreases, under-threshing of the grain decreases, grain separation decreases, power consumption decreases. As the developed length of the concave surface increases, the grain separation and straw breakage increase significantly (linearly) and grain damage is less intensive, while under-threshing substantially decreases. As the drum diameter increases from 380 mm to 800 mm, under-threshing increases, the drum kinetic energy increases, the drum rotation stabilizes due to smaller variation of its angular velocity, and with this, the grain separation and straw breakage decrease while the grain damage is practically unchanged and the likelihood of being wrapped up with straw decreases.

Furthermore, magnetically treating the edible portion of the crop with the same concave length drum and the same feed of the crop mass, smaller diameter (380-500 mm) threshing drums increase grain separation, capture the mass more actively and have lower under-threshing. The profile of drum hammers has considerable effect on the agricultural features and production performance of the threshing mechanism. An open drum (having open space between the hammers and hammer supports) with hammers having a 30°-60° active lead angle provides turbulent motion of threshed material in the threshing gap with prevailing longitudinal direction of grain movement from the drum center, which results in increased grain separation compared to other versions of hammer design.

A closed drum (a solid cylinder) with hammers attached to it that have no active lead angle, (i.e., under 30°) creates a more or less laminar flow of crop mass in the threshing gap with a prevailing tangential direction of gain movement that decreases the separation effect and grain damage. The “free cross-section” of the concave surface (the ratio of the area under the holes to the total concave area) has little effect on the under-threshing of grain, but as the “free cross-section” increases from 0% to 40% grain damage decreases considerably and grain separation increases. Straw breakage also increases, and the energy consumption of the process increases. The the distance between the concave bars from the start to the end of the concave must be variable, with larger distance in the first and last zones and smaller distance in the middle part of the concave surface.

The current method simplifies existing threshing processes and results in improved quality, since the magnetic field treats the entire volume of grain transported by transporting modules and passing through their active and passive zones.

Using the current method, edible portions of various crops are exposed to differing magnetic fields having optimum locations and magnetic strengths for each crop. The benefit of using the method is activating or suppressing targeted biological processes. For example, affecting germinating ability, thereby affecting ripening speed, crop yield quantity and quality, and in turn, storage life and other processes.

The theory of operation having been discussed, the physical layout of a typical application of the method will now be discussed.

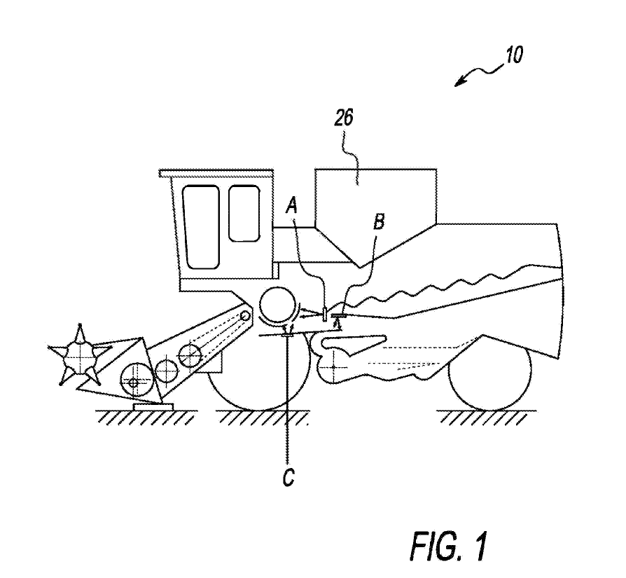

Referring to FIG. 1, a side view representing a combine harvester 10 is shown. The harvester 10 for harvesting a seed and grain crops includes a header 12, an inclined chamber 14, a threshing and separating unit 16, a transition grate 18, and a number of conventional parts including a grain carrier 20, distributing screw conveyors 22 and elevators 24 for moving grain to a grain hopper 26. The harvester 10 is fitted with first magnetic field generators A, second magnetic field generators B and third magnetic field generators C. The magnetic field generators A, B, C, are fitted to the thresher 10 along a process line at a first position 34 and second position 36, a third position 38 near the agitator board 40, and a fourth position 42 near the straw rack 44.

The most effective arrangement of the electromagnetic emitters will be set experimentally by sliding the magnetic emitters during movement of the grain while sampling grain. Since it is practically impossible to implement the method in a running harvester, installation of the emitters will be performed separately.

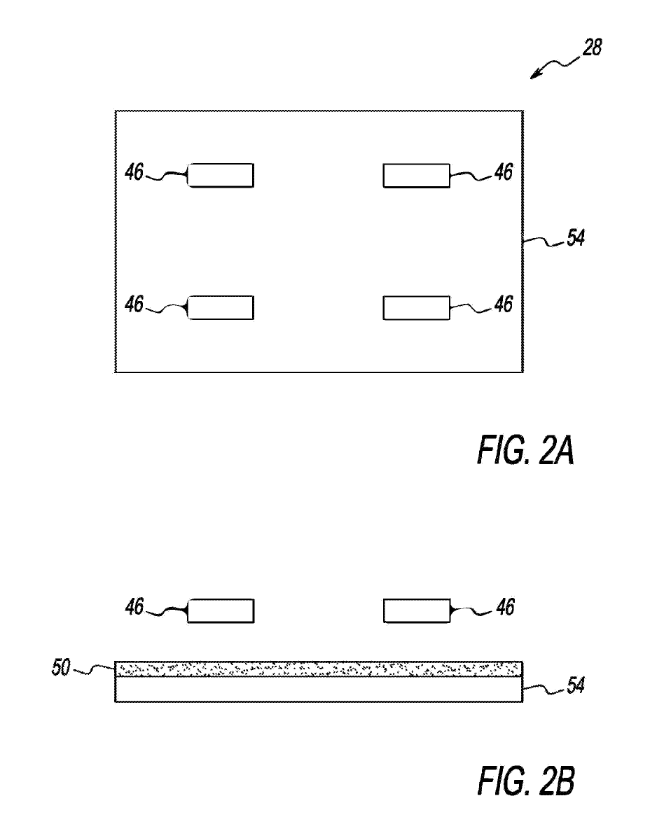

Referring to FIGS. 2A and 2B, emitters 46 are suspended at a distance of 60-100 mm from the surface of the leveling board 48 and are secured rigidly for transverse support between the side walls (not shown) of the harvester 10, so that none of structural elements of the leveling board 48 touch the emitters 46. A grain layer 50 on the leveling board 48 moves at a maximum speed of 1 m/s and has a thickness of 6 cm with a density of less than 250 kg/m³. This ensures free movement of the grain layer 50 under the emitters 46. This zone has a relatively thin and low density grain layer 50 which is exposed to magnetic fields at a low speed. The emitters 46 are installed preferably in two rows over the leveling board 48, outside of the concave 52 approximately 100-200 mm from the end 54 of the leveling board 48.

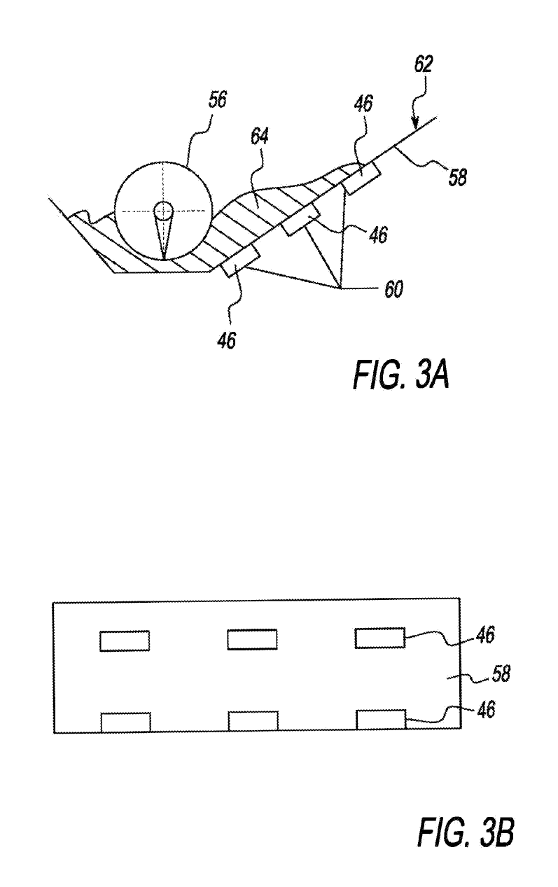

Referring to FIGS. 3A and 3B, the grain auger 56 is shown with sloped boards 58 near the auger 56. Slots 60 are made in a sloped board 58 to install emitters 46. The upper surface 62 of the sloped board 58, where the emitters 46 are, must be flush with the emitters 46. The location where the sloped board 58 and auger 56 converge is characterized by refined grains 64 with a density of approximately 700-750 kg/m³, which is moving at a rate of 3-5 m/s and has a layer thickness of 60-70 mm. Therefore, this is the location where higher density grain will be exposed to magnetic fields while moving at a high speed, with a relatively thick layer.

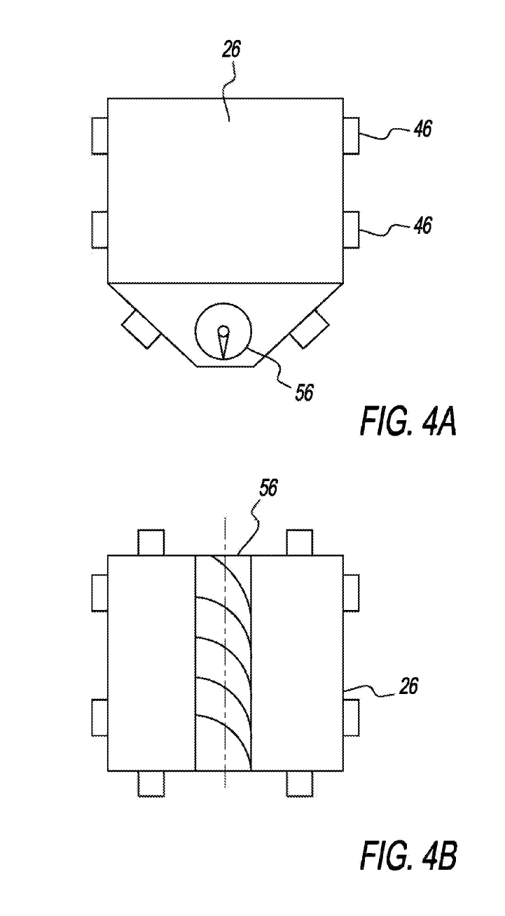

Referring to FIGS. 4A and 4B, a combine hopper 26 is shown. The hopper 26 is characterized by grain (not shown) stored relatively at rest in a resting layer 66 with thickness of 800-1200 mm. The average time for filling a hopper 26 with grain, depending on yield, is 15-40 minutes. The grain will be exposed to magnetic fields from the emitters 46 for a long time in a large and fixed layer.

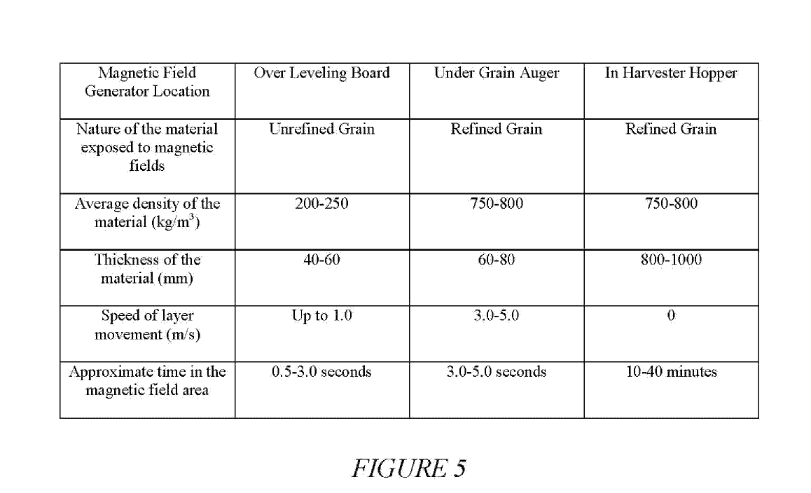

FIG. 5 is a table showing a summary of the three magnetic field generators, the nature of the grain being exposed to magnetic fields, the average density of the material exposed to magnetic fields, the thickness of the grain material, the speed of layer movement and the approximate amount of time in the magnetic fields.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A crop threshing method comprising:
threshing a grain causing the grain to separate into an edible grain portion and a non-gain portion of the crop;
the threshing process using a beater-type threshing drum, and continuously exposing the edible portion traveling through the threshing drum to a magnetic field.

2. The method of claim 1 wherein magnetic exposure of the edible portion during the threshing process is conducted by increasing the initial speed of crop mass fed into the threshing drum from 1.8 to 8.0 meters per second.

3. The method of claim 1 wherein a distance between threshing hammers during the threshing process is increased from 180 mm to 280 mm, and the number of threshing hammers is increased from six to twelve.

4. The method of claim 1 wherein magnetic exposure of the edible portion during the threshing process is conducted by increasing the developed length of a concave.

5. The method of claim 1 wherein the magnetic exposure of the edible portion during the threshing process is conducted by increasing the drum diameter from 380 mm to 800 mm with a constant developed concave length.

6. The method of claim 1 wherein the magnetic exposure of the edible portion during the threshing process is conducted using a threshing drum having a diameter of 380 mm to 500 mm, the threshing drum having the same concave length and the same feed of crop mass.

7. The method of claim 1 wherein the magnetic exposure of the edible portion during the threshing process is conducted with drum hammers having different profiles.

8. The method of claim 7, wherein the magnetic exposure of the edible portion during the threshing process is conducted using an open drum, open space between hammers and hammer supports, and with hammers having a 30° to 60° active lead angle.

9. The method of claim 7 wherein the magnetic exposure of the edible portion during the threshing process is conducted using a closed drum, a solid cylinder, and hammers attached to the solid cylinder having no active lead angle.

10. The method of claim 1 wherein the magnetic exposure of the edible portion during the threshing process is conducted by increasing the ratio of a area under holes in the drum to the total concave area from 0% to 40%.

11. The method of claim 1, wherein the magnetic exposure of the edible portion during the threshing process is conducted using a variable distance between concave bars from start to end of a concave surface, and with a larger distance in a first zone and a last zone, and a smaller distance in a middle zone of the concave surface.

12. The crop method of claim 1 wherein different magnetic fields are applied to the edible portion of each crop after ascertaining optimum magnetic field levels for each crop.
